(19) United States
(12) Patent Application Publication
(10) Pub. No.: US 2001/0040136 A1
(43) Pub. Date: Nov. 15, 2001

(54) Cationically charged coating on glass and nonwoven fibers

(75) Inventors: Ning Wei, Roswell, GA (US); Bashir Musse Sheikh-Ali, Duluth, GA (US)

Correspondence Address: Steven D. Flack, Esq., Kimberly-Clark Worldwide, Inc., 401 North Lake Street, Neenah, WI, 54956, US

(73) Assignee: Kimberly-Clark Worldwide, Inc.

(21) Appl. No.: 09/746,297

(22) Filed: Dec. 19, 2000

Related U.S. Application Data
(60) Provisional application No. 60/171,853, filed on Dec. 22, 1999.

(51) Int. Cl. B01D 37/00; B01D 39/14; B05D 3/00; B05D 3/10

(52) U.S. Cl. 210/767; 210/502.1; 210/508; 210/509; 427/384; 427/337

(57) ABSTRACT

A glass or pretreated meltblown fiber having a cationically charged coating thereon, the coating including a functionalized cationically charged, silicon containing carbohydrate polymer crosslinkable by heat, in which the functionalized cationic polymer has been crosslinked by heat after being coated onto the glass fiber. Also provided is a fibrous filter including a fibrous filter media having a cationically charged coating thereon, the coating including a functionalized cationic polymer crosslinkable by heat, in which the functionalized cationic polymer has been crosslinked by heat after being coated onto the fibers. Further provided is a method of preparing a fibrous filter. The method involves providing a fibrous filter which includes glass fibers or pretreated nonwoven fibers, passing a solution of a functionalized cationic starch polymer crosslinkable by heat through a fibrous filter under conditions sufficient to substantially coat the fibers with the functionalized cationic polymer, and treating the resulting coated fibrous filter with heat at a temperature and for a time sufficient to crosslink the functionalized cationic polymer present on the glass fibers.

The present application claims priority from U.S. Ser. No. 09/216,059 filed Dec. 18, 1998.

### TECHNICAL FIELD

The present invention relates to filter materials. More particularly, the present invention relates to charge-modified filters.

### BACKGROUND OF THE INVENTION

Charge-modified filters are known in the art. They typically consist of microporous membranes or involve the use of materials that are glass fibers, blends of glass fibers and cellulose fibers, or blends of cellulose fibers and siliceous particles. Charge modification generally is accomplished by coating the membrane or at least some of the fibers with a charge-modifying agent and a separate crosslinking agent in order to ensure the durability of the coating.

While microporous membranes generally are capable of effective filtration, flow rates through the membrane typically are lower than for fibrous filters. Moreover, microporous membranes generally have higher back pressures during the filtration process than do fibrous filters.

The use of fibrous filters prepared from synthetic polymers is desirable for the above stated reasons and also because such fibers are inexpensive and can be formed readily into nonwoven webs having porosities which are appropriate for the filtration of particles from a fluid stream. Many of such synthetic polymers (such as polyolefins) however are hydrophobic, a characteristic which makes it difficult to durably coat fibers prepared from such polymers with a charge modifying material.

In the past, electrostatically charged media for filter applications have been introduced to capture bacteria during a filtration process. Such filters are described for instance in U.S. Pat. Nos. 4,523,995, 4,734,208, 4,617,124, 4,007,113, 4,007,114, 4,617,128, and 4,305,782. In most of these cases, a mixture of multiple chemicals are needed to generate a cationically charged substrate and the chemicals are not a commodity edible product, that is a product that can normally come in contact with food or can be ingested.

Additionally, filter media has been described which includes microfiberglass with cellulose. In this regard, the cationic polymer Kymene has been described as being added to microfiberglass as a charge modifying material. Additionally, secondary cross linking agents have been used in such media. These additional cross linking agents are necessary for curing in these filters. However, these cross linking agents, upon reaction, may result in less effective bacterial captures as a result of the filter products having lower zeta potential. Further, the cross linking bonds may break with exposure to excessive water as a result of such secondary cross-linking chemistry, and as a result, the mechanical strength of such filters may be weak and susceptible to breaking down fairly easily.

Other filters require costly precipitating agents to make the coating more efficient. The manufacture of such filters therefore requires additional steps involving these precipitating agents. Additionally, several of these filter products require large add-on weights of as much as ten percent, which directly affect filtration efficiency by blocking pores and reducing flow rates through these filters.

Accordingly, there is a need for fibrous filters having effective filtration capabilities for charged particles. There is also a need for fibrous filters composed of hydrophilic fibers such as glass, without a requirement for a precipitation step, a separate crosslinking agent, or the presence of cellulosic fibers or siliceous particles. Finally, there is a need for an environmentally friendly filter which is electrokinetically charged via a relatively simple and cost effective process.

### BRIEF DESCRIPTION OF THE DRAWINGS

FIG. 1 is a schematic flow diagram for a process for manufacturing a filter media in accordance with the present invention.

FIG. 2 is a perspective view of an integrated filter utilizing filter media of the present invention.

FIG. 3 is a perspective view of an alternate embodiment of an integrated filter utilizing filter media of the present invention.

FIG. 4 is a graph demonstrating the bacterial capture of filter materials that have been coated using a crosslinked functionalized cationic starch of the present invention.

### SUMMARY OF THE INVENTION

The present invention addresses some of the difficulties and problems discussed above by providing a wettable substrate such as a glass fiber or nonwoven substrate, having a functionalized cationically charged silicon containing carbohydrate (polymer) coating thereon. The coating including the functionalized cationic polymer, has been crosslinked by heat, and is capable of crosslinking without the use of a secondary crosslinking agent. That is, the functionalized cationic polymer has been crosslinked by heat after being coated onto the fiber media. By way of example only, the functionalized cationic polymer may be a silicon containing polysaccharide. Such a polysaccharide desirably includes a charge density of between about 0.2 and 5.0 meq/g. More desirably, such a polysaccharide includes a charge density of between about 0.2 and 3.5 meq/g.

Furthermore, the present invention includes a functionalized cationic polymer which has been crosslinked by heat after being coated onto a meltblown fiber media that has been made hydrophilic. The meltblown fiber media may be made hydrophilic by first being coated with a wetting agent such as milk protein.

The present invention further provides a fibrous filter which includes glass or meltblown fibers having a cationically charged coating thereon. The coating includes a functionalized cationic polymer which has been crosslinked by heat. Again, the functionalized cationic polymer may be a charged silicon containing carbohydrate such as a polysaccharide.

The present invention also provides a method of preparing a fibrous filter. The method involves providing a wettable susbtrate (fibrous filter) which includes glass or meltblown fibers, passing a solution of a functionalized cationically charged, silicon containing carbohydrate polymer, crosslinkable by heat, through the fibrous filter under conditions sufficient to substantially coat the fibers with the functionalized cationic polymer, and treating the resulting coated fibrous filter with heat at a temperature and for a time sufficient to crosslink the functionalized cationic polymer present on the glass or meltblown fibrous filter. The functionalized polymer desirably has a charge density of between about 0.2 and 5.0 meq/g., more desirably between about 0.2 and 3.5 meq/g.

In an alternate embodiment of the present invention, the coating on the previously described substrate may be crosslinked by heat, and by an additional crosslinking agent comprising a tripolyphosphate.

The present invention further provides an integrated filter for removing impurities from a fluid stream, the filter including a first element adapted to remove at least some of the impurities by physical absorption; and a second element adapted to remove at least some of the impurities by electrokinetic adsorption, said second element being coated with a crosslinked functionalized cationically charged, silicon containing carbohydrate, capable of crosslinking without a secondary crosslinking agent.

Finally, the present invention also provides a method for filtering water for bacteria, by passing water to be filtered across a fibrous filter wherein the fibers of the filter have been coated with a functionalized cationically charged silicon containing carbohydrate polymer that has been crosslinked by heat.

The present invention provides a number of advantages over the materials known previously. First, the method of the present invention does not require the use of a separate or secondary precipitating or crosslinking agent. Second, the process does not use materials which are inherently unfriendly to the environment or that create residual products which are unfriendly to the environment. Third, the method of the present invention may be utilized in a continuous process on roll goods. Fourth, a cellulosic component is not required. Other advantages, of course, will be apparent to those having ordinary skill in the art.

### DETAILED DESCRIPTION OF THE INVENTION

As used herein, the terms “cationically charged” in reference to a coating on a glass or nonwoven fiber and “cationic” in reference to the functionalized polymer mean the presence in the respective coating and polymer of a plurality of positively charged groups. Thus, the terms “cationically charged” and “positively charged” are synonymous. Such positively charged groups typically will include a plurality of quaternary ammonium groups, but they are not necessarily limited thereto.

The term “functionalized” is used herein to mean the presence in the cationic polymer of a plurality of functional groups, other than the cationic groups, which are capable of crosslinking when subjected to heat. Thus, the functional groups are thermally crosslinkable groups. Examples of such functional groups include epoxy, ethylenimino, episulfido and unblocked siloxane. These functional groups readily react with other groups typically present in the cationic polymer. Such other groups typically have at least one nucleophile and are exemplified by amino, hydroxy, and thiol groups. It may be noted that the reaction of a functional group with another group often generates still other groups which are capable of reacting with functional groups. For example, the reaction of an epoxy group with an amino group results in the formation of a β-hydroxyamino group. Further, the functional groups may readily react with additional groups on a filter substrate.

Thus, the term “functionalized cationic polymer” is meant to include any polymer which contains a plurality of positively charged groups and a plurality of functional groups which are capable of being crosslinked by the application of heat. Particularly useful examples of such polymers are epichlorohydrin-functionalized polyamines and epichlorohydrin-functionalized polyamido-amines. Both types of polymers are exemplified by the Kymene® resins which are available from Hercules Inc., Wilmington, Del. Other suitable materials include cationically modified starches, such as RediBond, and Co-Bond™ 2500 from the National Starch and Chemical Company, in which polymer functional groups react with other functional groups within the polymer or within the filter substrate to cross-link upon application of heat.

As used herein, the term “thermally crosslinked” means the coating of the functionalized cationic polymer has been heated at a temperature and for a time sufficient to crosslink the above-noted functional groups. Heating temperatures typically may vary from about 50° C. to about 180° C. Heating times in general are a function of temperature and the type of functional groups present in the cationic polymer. For example, heating times may vary from less than a minute to about 60 minutes or more. Heating serves to drive off water to complete the condensation reaction.

The term “zeta potential” (also known as “electrokinetic potential”) is used herein to mean the difference in potential between the immovable liquid layer attached to the surface of a solid phase and the movable part of the diffuse layer in the body of the liquid. The zeta potential may be calculated by methods known to those having ordinary skill in the art. See, by way of example, Robert J. Hunter, “Zeta Potential in Colloid Science,” Academic Press, New York, 1981; note especially Chapter 3, “The Calculation of Zeta Potential,” and Chapter 4, “Measurement of Electrokinetic Parameters.” In the absence of sufficiently high concentrations of electrolytes, positively charged surfaces typically result in positive zeta potentials and negatively charged surfaces typically result in negative zeta potentials. When an electrolyte solution is forced, by external pressure, through a porous plug of material, a streaming potential develops. The development of this potential arises from the motion of ions in the diffusion layer. This streaming potential is measured with a Brookhaven-Paar BI-EKA instrument and its value is used to calculate the zeta potential. In this measurement, the glass or nonwoven samples are cut to size, 120 mm×50 mm, to fit inside the sample cell. Ag/AgCl electrodes are mounted at each end of the sample cell to measure the streaming potential.

As used herein the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al., the preceding patent being incorporated herein by reference.

As stated earlier, the present invention provides a glass or nonwoven fiber having a cationically charged coating thereon. The coating includes a functionalized cationic polymer crosslinkable by heat, in which the functionalized cationic polymer has been crosslinked by heat without the necessary use of a secondary crosslinking agent, after being coated onto the glass or pretreated meltblown fiber.

Particularly useful examples of functionalized cationic polymers are epichlorohydrin-functionalized polyamines and epichlorohydrin-functionalized polyamido-amines. Both types of polymers are exemplified by the Kymene® resins which are available from Hercules Inc., Wilmington, Del. Other suitable materials include cationically modified silicon containing carbohydrates (starches), such as RediBond, and Co-Bond™ 2500 from National Starch. Co-Bond™ 2500 has proven particularly useful as a cationic coating, as a result of its ability to crosslink intramolecularly without the need for a secondary crosslinking agent and its environmentally friendly attributes. Further, the use of a starch exemplified by Co-Bond™ 2500, is particularly effective as a cationic coating in that the charge group is available at the end of a long polymer chain, rather than being buried in the backbone of a polymer chain. Desirably, the functionalized cationic polymer will be an epichlorohydrin-functionalized polyamine, an epichlorohydrin-functionalized polyamido-amine or cationically charged polysaccharides as exemplified by Co-Bond™ 2500. Desirably, such polysaccharides have high charge densities up to approximately 5 meq/g, but more desirably between about 0.2 and 5.0 meq/g. Even, more desirably the charge density is between 0.2 and 3.5 meq/g.

The present invention further provides a fibrous filter including either a glass or pretreated meltblown fiber element having a cationically charged coating thereon and an activated carbon element. The coating is the functionalized cationic polymer crosslinkable by heat as described above.

In general, the fibrous filter will contain at least about 50 percent by weight of glass fibers, based on the weight of all fibers present in the filter. In some embodiments, essentially 100 percent of the fibers will be glass fibers. When other fibers are present, however, they generally will be cellulosic fibers, fibers prepared from synthetic thermoplastic polymers, or mixtures thereof.

Sources of cellulosic fibers include, by way of illustration only, woods, such as softwoods and hardwoods; straws and grasses, such as rice, esparto, wheat, rye, and sabai; canes and reeds, such as bagasse; bamboos; woody stalks, such as jute, flax, kenaf, and cannabis; bast, such as linen and ramie; leaves, such as abaca and sisal; and seeds, such as cotton and cotton linters. Softwoods and hardwoods are the more commonly used sources of cellulosic fibers; the fibers may be obtained by any of the commonly used pulping processes, such as mechanical, chemimechanical, semichemical, and chemical processes. Examples of softwoods include, by way of illustration only, longleaf pine, shortleaf pine, loblolly pine, slash pine, Southern pine, black spruce, white spruce, jack pine, balsam fir, douglas fir, western hemlock, redwood, and red cedar. Examples of hardwoods include, again by way of illustration only, aspen, birch, beech, oak, maple and gum.

Examples of thermoplastic polymers include, by way of illustration only, end-capped polyacetals, such as poly(oxymethylene) or polyformaldehyde, poly(trichloroacetaldehyde), poly(n-valeraldehyde), poly(acetaldehyde), and poly(propionaldehyde); acrylic polymers, such as polyacrylamide, poly(acrylic acid), poly(methacrylic acid), poly(ethyl acrylate), and poly(methyl methacrylate); fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), and poly(vinyl fluoride); polyamides, such as poly(6-aminocaproic acid) or poly(ε-caprolactam), poly(hexamethylene adipamide), poly(hexamethylene sebacamide), and poly(11-amino-undecanoic acid); polyaramides, such as poly(imino-1,3-phenyleneiminoisophthaloyl) or poly(m-phenylene isophthalamide); parylenes, such as poly-p-xylylene and poly(chloro-p-xylylene); polyaryl ethers, such as poly(oxy-2,6-dimethyl-1,4-phenylene) or poly(p-phenylene oxide); polyaryl sulfones, such as poly(oxy-1,4-phenylenesulfonyl-1,4-phenyleneoxy-1,4-phenylene-isopropylidene-1,4-phenylene) and poly(sulfonyl-1,4-phenyleneoxy-1,4-phenylenesulfonyl-4,4′-biphenylene); polycarbonates, such as poly(bisphenol A) or poly(carbonyidioxy-1,4-phenyleneisopropylidene-1,4-phenylene); polyesters, such as poly(ethylene terephthalate), poly(tetramethylene terephthalate), and poly(cyclohexylene-1,4-dimethylene terephthalate) or poly(oxymethylene-1,4-cyclohexylenemethyleneoxyterephthaloyl); polyaryl sulfides, such as poly(p-phenylene sulfide) or poly(thio-1,4-phenylene); polyimides, such as poly(pyromellitimido-1,4-phenylene); polyolefins, such as polyethylene, polypropylene, poly(1-butene), poly(2-butene), poly(1-pentene), poly(2-pentene), poly(3-methyl-1-pentene), and poly(4-methyl-1-pentene); vinyl polymers, such as poly(vinyl acetate), poly(vinylidene chloride), and poly(vinyl chloride); diene polymers, such as 1,2-poly-1,3-butadiene, 1,4-poly-1,3-butadiene, polyisoprene, and polychloroprene; polystyrenes; copolymers of the foregoing, such as acrylonitrile-butadiene-styrene (ABS) copolymers; and the like.

When fibers other than glass fibers are present in the fibrous filter, they desirably will be cellulosic fibers, fibers prepared from thermoplastic polyolefins, or mixtures thereof. Examples of thermoplastic polyolefins include polyethylene, polypropylene, poly(1-butene), poly(2-butene), poly(1-pentene), poly(2-pentene), poly(3-methyl-1-pentene), poly(4-methyl-1-pentene), and the like. In addition, such term is meant to include blends of two or more polyolefins and random and block copolymers prepared from two or more different unsaturated monomers. Because of their commercial importance, the most desirable polyolefins are polyethylene and polypropylene.

The present invention further provides a method of preparing a fibrous filter. The method involves passing a solution of a functionalized cationic polymer crosslinkable by heat through a fibrous filter which includes either glass or pretreated meltblown fibers under conditions sufficient to substantially coat the fibers with the functionalized cationic polymer, and treating the resulting coated fibrous filter with heat at a temperature and for a time sufficient to crosslink the functionalized cationic polymer present on either the glass or pretreated meltblown fibers.

In general, the solution of the functionalized cationic polymer will be an aqueous solution containing from about 0.1 to about 10 percent by weight, based on the weight of the solution, of the functionalized cationic polymer. For example, the solution may contain from about 0.1 to about 5 percent by weight of the functionalized cationic polymer. As another example, the solution may contain from about 0.1 to about 1 percent by weight of the functionalized cationic polymer.

In some embodiments, the aqueous solution of the functionalized cationic polymer may contain minor amounts of polar organic solvents that are soluble in or miscible with water. If present, such solvents generally will constitute less that 50 percent by volume of the liquid phase. For example, such solvents may constitute less than about 20 percent by volume of the liquid phase. Examples of such solvents include, by way of illustration only, lower alcohols, such as methanol, ethanol, 1-propanol, isopropanol, 1-butanol, isobutanol, and t-butyl alcohol; ketones, such as acetone, methyl ethyl ketone, and diethyl ketone; dioxane; and N,N-dimethylformamide.

Depending upon the functionalized cationic polymer, it may be either desirable or necessary to adjust the pH of the aqueous solution containing the polymer. For example, aqueous solutions of epichlorohydrin-functionalized polyamines or epichlorohydrin-functionalized polyamido-amines desirably have pH values which are basic or slightly acidic. For example, the pH of such solutions may be in a range of from about 6 to about 10. The pH is readily adjusted by means which are well known to those having ordinary skill in the art. For example, the pH may be adjusted by the addition to the polymer of a dilute solution of an acid, such as hydrochloric acid or sulfuric acid, or an alkaline solution, such as a solution of sodium hydroxide, potassium hydroxide, or ammonium hydroxide.

The solution of the functionalized cationic polymer may be passed through the fibrous filter by any means known to those having ordinary skill in the art. For example, the solution may be “pulled” through the filter by reducing the pressure on the side of the filter which is opposite the side against which the solution has been applied. Alternatively, the solution may be forced through the filter by the application of pressure.

Once the fibers of the filter have been coated with the functionalized cationic polymer, the polymer is crosslinked by the application of heat at a temperature and for a time sufficient to crosslink the functional groups present in the polymer. Temperatures typically may vary from about 50° C. to about 180° C. Heating times in general are a function of temperature and the type of functional groups present in the cationic polymer. For example, heating times may vary from about 1 to about 60 minutes or more with times between 5 and 10 minutes being desirable, especially for cationic starch materials such as Co-Bond™ 2500.

The present invention as it relates to Kymene type coatings are further described by the examples that follow. Such examples, however, are not to be construed as limiting in any way either the spirit or the scope of the present invention.

### KYMENE EXAMPLES

### Example 1

An aqueous solution containing 0.4 percent by weight of an epichlorohydrin-functionalized polyamido-amine (Kymene® 450, Hercules Inc., Wilmington Del.) was made by diluting 2 ml of stock Kymene® 450 solution (20 percent by weight solids) with 100 ml of deionized water. The pH of the solution was about 6 and was used without further adjusting its pH, since the effective pH range for Kymene® 450 is approximately 5 to 9. Twenty-five ml of this diluted Kymene® 450 solution were poured onto a 90 mm diameter microfiber glass filter (Whatman Type GF/D, having a pore size of 2.7 micrometers, Whatman International Ltd., Maidstone, England) which in turn had been placed in a coarse fritted glass funnel. The funnel was mounted in a filter flask to which a vacuum was applied to draw the solution through the glass filter over a period of 20 seconds, thereby coating the fibers with the polymer. The filter was removed from the funnel and heated in an oven at 85° C. for one hour to crosslink the polymer present on the fibers of the glass filter. After removal from the oven, the filter was washed with 500 ml of distilled, deionized water by the procedure used to coat the fibers. The washed, coated filter then was allowed to air dry.

Filter capture efficiency was tested against 0.5 micrometer diameter polystyrene latex microparticles (with carboxylic acid functional groups which gave a surface titration value of 7.0 eq/g) without surfactant (Bangs Laboratory, Inc., Fishers, Ind.) suspended in 100 ml of water at a concentration of 108 particles per ml. Two layers of 2-inch (about 5.1-cm) diameter filter discs cut from the 90 mm disc were placed in a 2-inch (about 5.1-cm) diameter Nalgene reusable filter holder (250 ml, Nalgene # 300-4000, Nalge Nunc International, Naperville, Ill.). The particle solution was passed through the filters by gravity. Greater than 99.9 percent of the particles were removed by filtering the solution through the coated glass filters which had a combined basis weight of 6 ounces per square yard or osy (about 203 grams per square meter or gsm).

The Whatman glass filter had a zeta potential before being coated of −46 millivolts and a zeta potential after being coated of 16-36 millivolts. The zeta potentials of solid membranes were determined from measurements of the streaming potentials generated by the flow of a potassium chloride solution (10 mM in distilled water, at a pH of 4.7 and a temperature of 22° C.) through several layers of membranes which were secured in a membrane holder on an Electro Kinetic Analyzer (EKA, Brookhaven Instruments Corporation, Hotlsville, N.Y.). The testing procedures and calculation methods were published by D. Fairhurst and V. Ribitsch in “Particle Size Distribution II, Assessment and Characterization,” Chapter 22, ACS Symposium Series 472, edited by Theodore Provder.

### Example 2

The procedure of Example 1 was repeated, except that the heating time for crosslinking the polymer present on the fibers of the filter was reduced from one hour to ten minutes. Filter capture efficiency was carried out as described in Example 1 with the same results.

### Example 3

The procedure of Example 2 was repeated, except that the heating temperature for crosslinking the polymer present on the fibers of the filter was increased to 100° C. Filter capture efficiency was carried out as described in Example 1 with the same results.

### Example 4

An aqueous solution containing 0.4 percent by weight of an epichlorohydrin-functionalized polyamido-amine (Kymene® 450, Hercules Inc., Wilmington Del.) was prepared as described in Example 1. Twenty-five ml of this Kymene® 450 solution were poured onto a 90 mm diameter microfiber glass filter (LB-5211-A-O, from Hollingsworth & Vose Company, East Walpole, Mass., containing 3-7% acrylic resin binder and a 0.5 osy or about 17 gsm Reemay supporting scrim) which in turn had been placed in a coarse fritted glass funnel. The funnel was mounted in a filter flask to which a vacuum was applied to draw the solution through the glass filter over a period of 20 seconds, thereby coating the fibers with the polymer. The filter was removed from the funnel and heated in an oven at 85° C. for one hour to crosslink the polymer present on the fibers of the glass filter. After removal from the oven, the filter was washed with 1,000 ml of distilled, deionized water by the procedure used to coat the fibers. The washed, coated filter then was allowed to air dry.

A single layer of a 2-inch (about 5.1-cm) diameter filter disc cut from the 90 mm disc was placed in a 2-inch (about 5.1-cm) diameter Nalgene reusable filter holder as described in Example 1. One hundred ml of a 0.1 percent by weight sodium chloride solution was passed through the filters by gravity. After the saline solution washing, the filter capture efficiency was tested against 200 ml of the 0.5 micrometer diameter polystyrene latex microparticles without surfactant described in Example 1. The 200 ml (containing 10⁸ particles per ml) of particle solution were prepared by mixing 100 ml of a 0.2 percent by weight sodium chloride solution with 100 ml of a 2×10⁸ particles/ml particle solution. The resulting solution then was passed through the filter by gravity. Greater than 99.9 percent of the particles were removed by filtering the solution through the coated glass filter which had a basis weight of 2.2 osy (about 75 gsm).

### Example 5

The procedure of Example 4 was repeated, except that the microfiber glass filter employed was LA-8141-O-A, also from Hollingsworth & Vose Company, East Walpole, Mass., and also containing 3-7% acrylic resin binder and a 0.5 osy or about 17 gsm Reemay supporting scrim. As in Example 4, greater than 99.9 percent of the particles were removed by filtering the solution through the coated glass filter; in this example, the coated glass filter had a basis weight of 2.5 osy (about 85 gsm).

### Additional Test Methods and Examples Pertaining to Functionalized Cationic Starch Polymers

Particularly effective starches for use on filter substrates include polysaccharide starches with pendent crosslinkable side chains. Desirably, such starches contain functionalized side groups such as unblocked siloxane groups, which are capable of crosslinking to each other, and perhaps a substrate. An example of such a starch is Co-Bond™ 2500 available from National Starch and Chemical Company. It has been found that such starch proves to be durable when applied to a glass filter substrate. Additionally, such starch may be applied in a simplified process that is also quickly accomplished. Such starch demonstrates wet-strength properties, making it suitable for a coating of a filter media, hydrophilicity, and is environmentally friendly. Filters made with such starches consequently have applications in drinking water filtration systems, industrial water filtration systems, pharmaceutical water filtration systems, air filtration systems and in electronic industry water filtration systems, where filtrate efficiency and safety are of the utmost concern.

The present invention provides a method/process of preparing a fibrous filter media utilizing a functionalized cationic starch. The method involves providing a fibrous filter media comprising hydrophilic fibers; treating the fibrous filter with an aqueous solution of a functionalized starch polymer crosslinkable by heat without the necessary use of a secondary crosslinking agent and under conditions sufficient to substantially coat the fibers with the functionalized starch polymer; and treating the resulting coated fibrous filter with heat at a temperature and for a time sufficient to crosslink the functionalized starch polymer present on the hydrophilic polymer fibers.

One type of fibrous filter matrix comprising hydrophilic fibers that is particularly suited to this invention is a microfiber glass filter matrix manufactured by Hollingsworth & Vose Company of East Walpole, Mass., designated as LB-5211 A-O, having an untreated basis weight of 25 osy. It should be noted that to convert an “osy” designation into a “gsm” multiply osy by 33.91. Another example of inherently hydrophilic fibers are nonwoven polyamides such as nylon 6, which may be used in the form of a meltblown nonwoven web.

As stated earlier, one type of functionalized starch polymer that is particularly suited to this invention is Co-Bond™ 2500 manufactured by National Starch and Chemical Company. Co-Bond™ 2500 is typically sold as a 15% by weight solution of the functionalized starch polymer in water. Co-Bond™ 2500 is a quartenary amine-based starch with unblocked siloxane functionality.

An aqueous solution of functionalized starch polymer is prepared by diluting the functionalized starch solution in water. As a practical matter, the aqueous solution of the functionalized starch polymer typically will include from about 0.1 to about 3.0 percent by weight of the functionalized starch polymer. Desirably, the aqueous solution of the functionalized starch polymer will include from about 0.1 to about 2.0 percent by weight of the functionalized starch polymer. More desirably, the aqueous solution of the functionalized starch polymer will include about 1.5% by weight of the functionalized starch polymer.

Depending upon the functionalized starch polymer, it may be either desirable or necessary to adjust the pH of the aqueous solution containing the polymer. For example, aqueous solutions of functionalized starch polymers have pH values that range from slightly acidic to basic. For example, the pH of such solutions may be in a range of from about 6 to about 13. The pH is readily adjusted by means that are well known to those having ordinary skill in the art. For example, the pH may be adjusted by the addition to the polymer solution of typically dilute solutions of an acid, such as hydrochloric acid or sulfuric acid, or an alkaline solution, such as a solution of sodium hydroxide, potassium hydroxide, or ammonium hydroxide. The pH of the solution of Co-Bond™ 2500 may therefore be adjusted, although it should be noted that a change in pH was not shown to have noticeably changed the starch performance.

Application of the aqueous solution of functionalized starch polymer is done by dipping a handsheet of the fibrous filter matrix comprising hydrophilic fibers into a bath containing the aqueous solution of functionalized starch polymer. The handsheet remains in the bath until it is saturated with the aqueous solution.

The handsheet is then removed from the bath and placed into an oven where the crosslinking of the functionalized starch polymer occurs. The crosslinking temperature is desirably in the range of from about 50° C. to about 180° C., more desirably in the range of from about 100° C. to about 180° C., even more desirably about 1400 to 160° C. A conventional type of oven may be utilized for this purpose, but one skilled in the art will appreciate that other types of ovens will work as well. The handsheet remains in the oven for a period of time ranging from about 2 minutes to about 10 minutes, more typically for a period of time of about 5 minutes. After the coating has been crosslinked on the fiber matrix, the handsheet is removed from the oven and washed in about 2 liters of distilled water to remove residual functionalized starch. It has been found that this time period for heating is sufficient to induce crosslinking intramolecularly in the functionalized cationic starch, and between the functional cationic starch and the filter media.

In an alternative embodiment of the present invention, crosslinking of the starch is further enhanced by an additional crosslinking agent. In particular, when used with sodium tripolyphosphate as an additional cross-linking agent, such starch demonstrates stronger adherence to a glass fiber substrate. In such a situation, the sodium tripolyphosphate is introduced into the process by mixing it in a functionalized cationic starch solution. The solution is then applied as previously described.

In still a further embodiment of the present invention, the functionalized cationic starch polymer includes a charge density of up to 5.0 meq/g. Desirably, the charge density is in the range of 0.2 to 5.0 meq/g, more desirably between about 0.2 to 3.5 meq/g.

Finally, in still a further embodiment of the present invention, the cationic starch is coated on a meltblown filter substrate that is not inherently wettable or hydrophilic, such as a polyolefin, but that is first made wettable by being pretreated so as to make it hydrophilic in nature. Such a meltblown substrate may be made wettable by pretreating the substrate with milk protein, such as drawing a 2% milk solution such as that obtained from a grocery store through the substrate or through positive pressure, forcing the solution through the substrate. Other wetting agents include hydrophilic polymers such as polyvinyl alcohol, polyethylene oxide (PEO), food grade surfactants such as T-MAZ80K, available from BASF Corporation, and amphiphilic polymers. If the substrate requires pretreatment in order to make it hydrophilic, the following pretreatment process steps should be followed. One such process involves (a) passing a 2-wt % skim milk powder in mild water (40 to 70° C.) through individual non-wettable filter media and (b) drying in air. The process of “passing milk through the non-wettable nonwoven web” may be achieved in (a) a filtration setting where the fluid is pressed or drawn through the web or in (b) a continuum process where a submerged vacuum or pressure orifices force the milk solution to pass through the web and, in the process, coats a moving web. Upon passing the milk solution through the meltblown substrate and air drying it, the medium becomes instantaneously wettable by water. It should be recognized that if nylon meltblown or glass fibers are used as the filter media, the milk pretreatment is not necessary. Inherently hydrophobic nonwoven webs, and in particular meltblown webs, may be made from polyolefins, such as polypropylene, as are available from the Kimberly-Clark Corporation under the designation meltblown 1102.

If the inventive process is to be used on an inherently hydrophobic nonwoven web as a filter media the following process steps would then be followed: a) providing a fibrous filter media comprising hydrophobic fibers; b) pretreating the hydrophobic filter media to make it wettable; c) treating the fibrous filter with an aqueous solution of a functionalized starch polymer crosslinkable by heat without the necessary use of a secondary crosslinking agent and under conditions sufficient to substantially coat the fibers with the functionalized starch polymer; and treating the resulting coated fibrous filter with heat at a temperature and for a time sufficient to crosslink the functionalized starch polymer present on the hydrophilic polymer fibers.

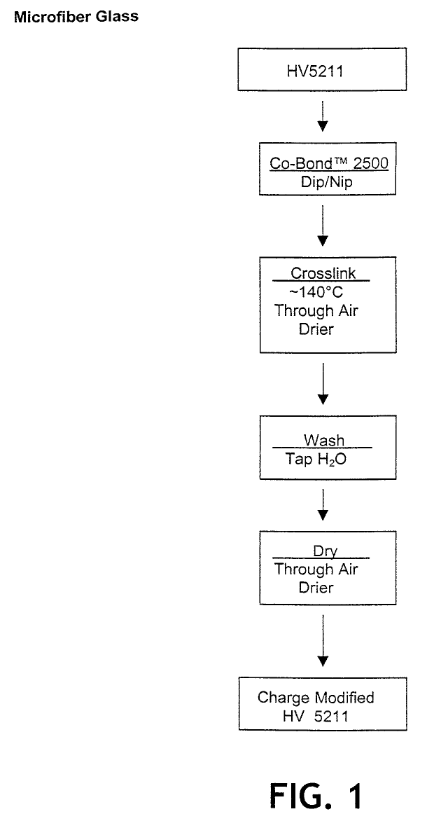

A process is illustrated in FIG. 1 which shows in a schematic flow chart, the process steps for treating an inherently hydrophilic web. In step 1, a microfiber glass web is first saturated with an aqueous starch solution, and in particular a Co-Bond™ 2500 starch solution in the range of about 0.1% to 2% by weight. Desirably, the starch solution is in a concentration of about 1.5% by weight. The filter media is run through a dip and nip process, that is a dip bath and then a nip system to force off excess starch solution. It has been found that having a pH of between 6 and 12 for these solutions does not appreciably change the performance of the final coated web. If the filter media to be used is inherently hydrophobic in nature, such as a meltblown polyolefin, the process would include a pretreatment step of coating the web with milk protein first (as described earlier) prior to coating the web with the starch coating. In step two of the process, the starch coated filter media is crosslinked through exposure to heat. In particular, the filter media is heated in a dryer at between about 100-180° C., desirably between 140-160° C.

The coated filter media is heated at around 140° C. In step three of the process, the filter media is washed in ordinary tap water at about 100 psi for about 5 minutes. In step four of the process, the filter media is dried in a through air dryer producing a charge modified filter media.

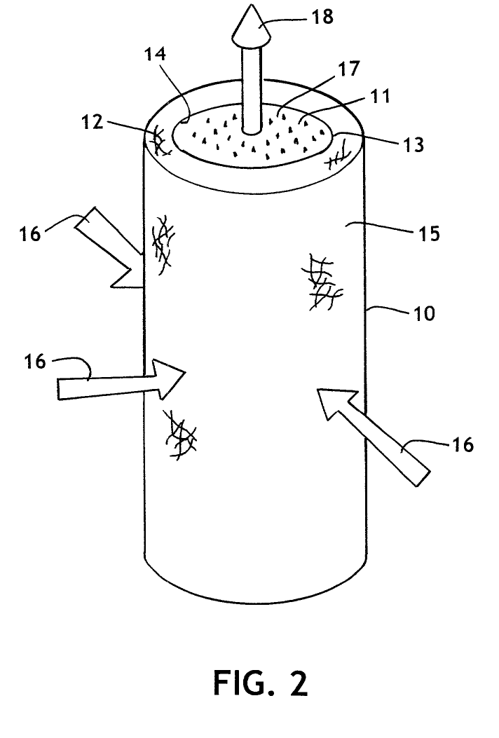

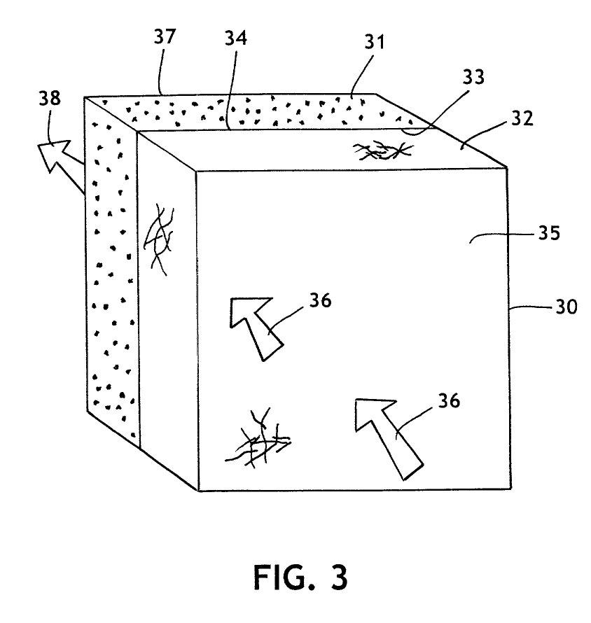

Such a filter media may then be incorporated into a filter structure as illustrated in FIGS. 2 and 3 which illustrates several integrated filters utilizing fibrous filter media prepared in accordance with the present invention. The integrated filter removes impurities from a fluid stream. The filter includes a first element adapted to remove at least some of the impurities by physical adsorption, and a second element adapted to remove at least some of the impurities by electrokinetic adsorption. The first element is composed of a porous block of an adsorbent, wherein the block is permeable to fluids and has interconnected pores therethrough, and the second element is composed of a porous, charge-modified fibrous web as defined above. Again, either or both of the first element and the second element further is adapted to remove at least some of the impurities by sieving. The first element can be activated carbon, activated alumina, activated bauxite, fuller's earth, diatomaceous earth, silica gel, or calcium sulfate. Additionally, it may include a thermoplastic binder.

Referring now to FIG. 2, a filter 10 is shown consisting of a first element 11 and a second element 12. The first element 11 is a solid cylindrical extruded activated carbon block. The second element 12 is the charge-modified web as previously described (either nonwoven or glass) wrapped around the first element 11. The elements 11 and 12 are concentric and continuous; the outer surface 13 of the first element 11 is contiguous with the inner surface 14 of the second element 12. To use the filter 10, a fluid, such as water or air, may enter the integrated filter 10 at the outer surface 15 of the second element 12, as indicated by arrows 16. The fluid may flow through the second element 12 into the first element 11 and exit from an end 17 of the first element 11, as indicated by arrow 18. If desired, the second element 12 may consist of a single layer as shown, or a plurality of layers which may be the same or different.

Alternatively, the elements shown in FIG. 2 may take the form of flat sheets, rather than cylinders as shown in FIG. 3. In FIG. 3, the filter 30 consists of a first element 31 and a second element 32. The first element 31 is an extruded activated carbon block in the form of a sheet. The second element 32 is the charge-modified web (as previously described) adjacent to and contiguous with the first element 31. Thus, the outer surface 33 of the first element 31 is contiguous with the inner surface 34 of the second element 32. To use the filter 30, a fluid, such as water or air, may enter the integrated filter 30 at the outer surface 35 of the second element 32, as indicated by arrows 36. The fluid will flow through the second element 32 into the first element 31 and exit from the outer surface 37 of the first element 31, as indicated by arrow 38.

A method of filtering bacteria from water therefore comprises passing water through a filter including a fibrous filter media which has been coated with a functionalized cationically charged starch which is capable of crosslinking without the necessity of a secondary crosslinking agent.

The present invention is further described by the examples that follow. Such examples, however, are not to be construed as limiting in any way either the spirit or the scope of the present invention. For the purposes of the examples utilizing such starches, the following test methods were followed.

Treatment Add-on:

The purpose of the treatment add-on test was to determine the amount of chemical that was cross-linked to any particular filter material. Treatment add-on is determined by weight difference.

For materials treated as handsheets, handsheets of filter material were weighed before and after being treated by the process of applying starch coatings. Treatment add-on was calculated as the weight difference before and after, the difference being divided by the initial weight of the filter handsheet. For materials treated by a continuous treatment process, average initial basis weight was obtained by weighing twenty-five 1.875 inch diameter samples cut with a die cutter and mallet. (and taking weight average). For treated material, three or more 1.875 inch samples were cut with a die cutter and mallet and weighed to determine the basis weight (average). Basis weight of treatment add-on was then determined by subtraction.

Treatment add-on is expressed as grams of treatment per gram of untreated fabric, or g/g. By way of example, if an 8.5 inch by 11.0 inch sheet of filter material had an initial untreated weight of 5.1 grams and a final treated weight of 5.2 grams, the treatment add-on would be (5.2 grams−5.1 grams)/5.1 grams=0.02 g/g.

Bacteria Capture:

Pathogen filter efficacy is defined herein as the ratio of the number of bacterial cells remaining in the filtrate to the number of bacterial cells originally present in the pathogen suspension. It is determined by plating samples of both the original suspension and the filtrate on tryptic soy agar (TSA) growth media plates (BBL ® TSA plates, Becton-Dickinson, Cockeyville, Md.), and counting the number of colonies seen after overnight incubation at 37° C. One colony forming unit (CFU) translates to one individual viable cell.

A single layer of the treated microfiber glass was placed in a filter housing apparatus (Nalgene Filter Holder, Nalgene Inc., Rochester, N.Y.). Filter efficacy was determined by challenging the filter with 100 milliliters (ml) of contaminated 0.1 percent saline. Bacterial contamination was controlled and set to 105-106 cells/mi. Flow through the filter was either by gravity flow or under the influence of a vacuum. As with the coated durability, the effluent saline was incubated for thirty minutes. Cell concentrations were determined as described above after plating and overnight culturing at 37° C. The results were compared to the plate counts for the original suspension and recorded as a log reduction. Log reduction is calculated as log 10.

Sink Test:

The purpose of the sink test is to determine the hydrophobic/hydrophilic nature of a particular filter material. Longer sink times indicate a material that is more hydrophobic in nature, while shorter sink times indicate a material more hydrophilic in nature.

To perform the test 1.875 inch diameter samples of filter material were cut using a die cutter and mallet. A single sample of filter material was then dropped into a 250 millilter beaker containing about 150 milliliters of distilled water. A timer was started as the sample contacts the water. After a period of 10 seconds, the beaker was shaken lightly to dislodge any air bubbles that may have attached to the sample. The timer was stopped when the sample contacts the bottom of the beaker. The “sink time” is then recorded.

Flow Rate Test:

The purpose of the flow rate test is to determine a representative flow rate measurement for treated filter materials. Higher flow rates are indicative of a material less resistant to flow, while lower flow rates are indicative of a material more resistant to flow. To perform the test, 1.875 inch diameter samples of filter material were cut using a die cutter and mallet. Each sample was placed in a Nalgene filter assembly. The Nalgene filter assembly consists of three parts: 1) a bottom receiver which collects the filtrate and which has two portals for vacuum extraction, 2) the filter holder, which supports the material being tested, and 3) the top of the assembly, which holds the challenge solution and seals the filter test media in place. After the filter material had been placed in the Nalgene filter assembly, 100 milliliters of de-ionized water of 1% by weight NaCl solution were introduced into the top of the Nalgene filter assembly. A vacuum box was then applied to the bottom receiver until only 2 to 3 milliliters of liquid were left in the top of the assembly, at which point the vacuum source was removed and the remaining fluid was allowed to soak through the filter sample. The filtrate was then removed from the bottom receiver. A timer was started as a second 100 milliliters of deionized water or 1% by weight NaCl solution was poured into the top of the Nalgene filter assembly. The timer was stopped as the last drop of liquid was absorbed into the filter sample. The flow rate time was then recorded.

A variation on this test includes running it at constant head whereby a specific quantity of fluid is maintained in the top of the filter assembly while a second specific quantity of fluid is permitted to soak through the filter. A second variation is to apply a specific level of vacuum to the bottom receiver during the timed portion of the test. Results may be reported as milliliters/minute/inch², gallons/hour, or other appropriate flow rate units that will be obvious to those skilled in the art.

### Example 6

2 ml of Co-Bond™ 2500 (15% solid) obtained from National Starch was dissolved in 98 ml of distilled water. The solution was stirred well. An eight by ten inch Hollingsworth & Vose LB 5211-AO micro-fiber glass sheet was soaked in the solution for 1 minute. It should be noted that the glass filter media consisted of glass microfibers with 3-7% acrylic resin binder. The supporting scrim of the filter is a 0.5 oz/yd² Reemay, a high strength spunbonded polyester nonwoven. The scrim can be applied to either side of the filter. The scrim is bonded to the glass media using a polyester hot melt which has a melting point of 325° F. The sheet was taken out and the excess of solution was let drained for approximately 2 minutes. Thereafter, it was placed into an oven at 200° F. for five minutes to crosslink. It should be noted that the material is instantly wettable. The treated material was cut into 1⅞ inch discs and washed with two liters of distilled water and the filtrate was tested for leaching of any antimicrobial agent (coating). The test results indicated that there was no leaching. In addition, one layer of 1⅞ inch size filter was challenged with 1000 ml of 2.17E6 cfu/ml Klebsiella at the flow rate of 500 ml/mn. The pathogen capture was 2.95 log indicating that the coating could have effective and high capacity for pathogen removal.

### Additional Example Test Conditions

Additional base filter substrate was obtained from the Hollingsworth & Vose company under the designation LB-5211 A-O. It should be noted that these glass fibers are inherently hydrophilic and therefore require no additional additives or treatment to make them hydrophilic in a filter. In the additional examples Co-Bond™ 2500 (15% solid) obtained from National Starch was again dissolved in distilled water to produce a solution percent of between 0.1 and 2.5. The solution was stirred well. An eight by ten inch Hollingsworth & Vose LB 5211-AO micro-fiber glass sheet was soaked in the solution for 1 minute. The sheet was taken out and the excess of solution was let drained for approximately 2 minutes. Thereafter, it was placed into an oven at a temperature of between about 116 and 180° C. for five minutes to induce thermal crosslinking intramolecularly and between the starch and the filter media substrate. It should be noted that the material is instantly wettable. One layer of 1⅞ inch size filter was challenged with 1000 ml of 2.17E6 cfu/ml Klebsiella at the flow rate of 500 ml/mn. The pathogen capture for the samples was as high as 5.19 log, indicating that the coating could have effective and high capacity for pathogen removal. Data for the 45 additional samples produced by this method are shown in the following Table 1.

TABLE I

| | Solution | Oven | Time | Add-on | Bacteria Capture | | Sink Test | Flow Rate |
|---|---|---|---|---|---|---|---|---|
| Example | Percent | Temp. ° C. | minutes | g/g | 100 ml | 1000 ml | seconds | ml/min/in² |
| 1 | — | — | — | 0 | | | 470 | |
| 2 | 01 | 116 | 6 | 0.00 | | 193 | 323 | 2340 |
| 3 | 03 | 116 | 5 | 001 | | 2.10 | 300 | 22.75 |
| 4 | 06 | 116 | 5 | 004 | | 2.56 | 297 | 22.60 |
| 5 | 10 | 116 | 5 | 005 | | 273 | 273 | 1890 |
| 6 | 15 | 116 | 5 | 0.09 | | 2.30 | 237 | 19.46 |
| 7 | 20 | 116 | 5 | 007 | | 274 | 240 | 1445 |
| 8 | 25 | 116 | 5 | 0.12 | | 088 | 273 | 10.53 |
| 9 | 06 | 140 | 5 | 004 | | | 183 | 23.89 |
| 10 | 10 | 140 | 5 | 008 | | 322 | 22.3 | 20.66 |
| 11 | 1.5 | 140 | 5 | 005 | | 5.19 | 277 | 21.33 |
| 12 | 2.0 | 140 | 5 | 012 | | 519 | 200 | 1791 |
| 13 | 25 | 140 | 5 | 011 | | 3.28 | 277 | 1605 |
| 14 | 0.6 | 160 | 5 | 005 | | | 21.7 | 2069 |
| 15 | 10 | 160 | 5 | 008 | | | 227 | 1914 |
| 18 | 15 | 160 | 5 | 0.08 | | 238 | 22.3 | 1685 |
| 17 | 20 | 160 | 5 | 010 | | | 197 | 1262 |
| 18 | 25 | 160 | 5 | 015 | | | 227 | 1190 |
| 19 | 06 | 160 | 5 | 002 | | | 23.3 | 20.59 |
| 20 | 10 | 180 | 5 | 0.05 | | | 240 | 1677 |
| 21 | 1.5 | 180 | 5 | 009 | | | 233 | 17.87 |
| 22 | 20 | 180 | 5 | 010 | | 2.44 | 220 | 1601 |
| 23 | 2.5 | 180 | 5 | 0.08 | | | 21.7 | 11 53 |
| 24 | 15 | 138 | 2 | 004 | | | 36.0 | 18.47 |
| 25 | 15 | 138 | 2 | 002 | | | 413 | 2231 |
| 26 | 06 | 116 | 5 | 007 | | | 22.0 | 24.23 |
| 27 | 10 | 116 | 5 | 007 | 5.56 | 1.92 | 25.0 | 22.06 |
| 26 | 15 | 116 | 5 | 0.09 | 5.56 | 1.73 | 21.7 | 17.59 |
| 29 | 20 | 116 | 5 | 0.14 | | | 22.3 | 1884 |
| 30 | 06 | 140 | 5 | 006 | | | 217 | 24.75 |
| 31 | 10 | 140 | 5 | 008 | 556 | 1.91 | 203 | 2151 |
| 32 | 1.5 | 140 | 5 | 0.11 | 556 | 138 | 233 | 17.44 |
| 33 | 2.0 | 140 | 5 | 012 | | | 203 | 1748 |
| 34 | 06 | 160 | 5 | 003 | | | 203 | 22.87 |
| 35 | 10 | 160 | 5 | 005 | 556 | 110 | 233 | 2163 |
| 36 | 15 | 180 | 5 | 008 | 556 | 026 | 217 | 1658 |
| 37 | 20 | 160 | 5 | 009 | | | 207 | 1847 |
| 38 | 10 | 140 | 5 | 0.08 | | | 200 | 20.74 |
| 39 | 15 | 140 | 5 | 008 | | | 223 | 17.22 |
| 40 | 1.5 | 140 | 5 | 001 | | 357 | 277 | 1908 |
| 41 | 15 | 140 | 5 | 008 | | 293 | 25.3 | 21.82 |
| 42 | 12 | 116 | 5 | 006 | | 097 | 20.3 | 15.70 |
| 43 | 10 | 116 | 5 | 006 | | 274 | 213 | 1568 |
| 44 | 8 | 116 | 5 | 0.07 | | 256 | 22.0 | 17.02 |
| 45 | 6 | 116 | 5 | 006 | | 2.05 | 217 | 18.15 |

*It should be noted that the pH of the Samples 42-45 ranged from 6-12.

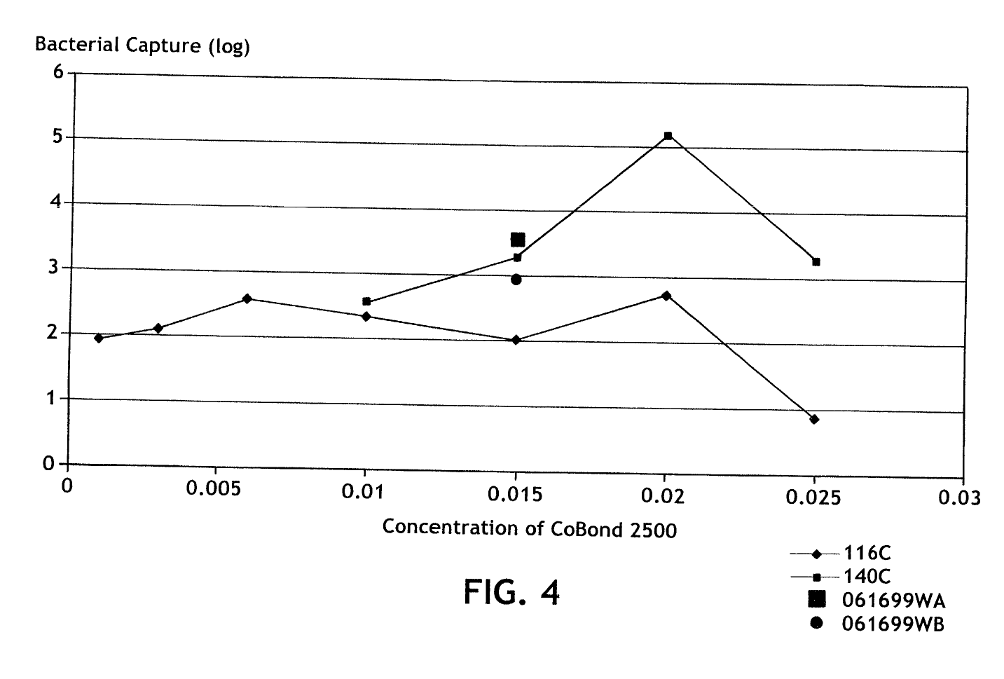

The Bacteria Capture test results are illustrated in FIG. 4. From the figure, it can be seen that at a higher heating temperature, such as at 140° C., it is likely that a greater degree of crosslinking is occurring, consequently resulting in higher bacteria capture results.

A final experiment was performed with a solution of Co-Bond™ 2500 and tripolyphosphate in which a starch solution of 0.50% by weight Co-Bond™ 2500 was prepared with 0.025 g sodium tripolyphosphate and applied to a microfiber glass saturate as previously described. The add on for the experiment was 4.3% and the results were a Sink Test of 17.7 seconds and a flow rate of 31.55 ml/min. It therefore can be seen that cationic starch with functional groups offer an environmentally friendly filter coating. By utilizing a cationically charged starch with the ability to crosslink without the need for a secondary crosslinking agent, manufacture of such a filter is easier.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A filter medium comprising of:
a) a wettable substrate; and
b) a cross-linked coating on the surfaces of said substrate of a functionalized cationically charged, silicon containing carbohydrate, capable of crosslinking without a secondary crosslinking agent.

2. The filter medium of claim 1 wherein said substrate comprises a fiber matrix.

3. The filter medium of claim 2 wherein said fiber matrix comprises one or more types of fibers selected from meltblown fibers, staple fibers, and spunbond fibers.

4. The filter medium of claim 3 wherein said types of fibers are formed from a polyolefin.

5. The filter medium of claim 4 wherein said polyolefin is polypropylene.

6. The filter medium of claim 3 wherein said types of fibers are formed from a polyamide.

7. The filter medium of claim 6 wherein said polyamide is nylon-6.

8. The filter medium of claim 3 wherein said staple fibers are formed from glass.

9. The filter medium of claim 1 wherein said cross-linked coating of a functionalized cationically charged, silicon containing carbohydrate, comprises a polysaccharide having unblocked siloxane groups prior to crosslinking, and including a charge density of between about 0.2 and 5.0 meq/g

10. The filter medium of claim 9 wherein said charge density is between about 0.2 and 3.5 meq/g.

11. A process for preparing a filter medium comprising:
a) forming a wettable substrate, then;
b) applying a cross-linkable coating of a functionalized cationically charged, silicon containing carbohydrate to the surface of said wettable substrate under conditions sufficient to substantially coat the fibers with the functionalized cationic carbohydrate, and
c) crosslinking said functionalized cationic carbohydrate coating.

12. The process of claim 11 wherein said step of crosslinking is accomplished with the assistance of a secondary crosslinking agent.

13. The process of claim 12 wherein the secondary crosslinking agent is sodium tripolyphosphate.

14. The process of claim 11 wherein said step of crosslinking is accomplished by heating at a sufficient temperature and time

15. The process of claim 11 wherein said forming of said wettable substrate further comprises the steps the steps of:
a) forming a fiber matrix, then;
b) applying a milk treatment to make said fiber matrix wettable.

16. The process of claim 11 wherein said step of applying a functionalized cationically charged, silicon containing carbohydrate to the surface of said wettable substrate further comprises:
a) dipping said wettable substrate into a starch and water solution,
b) removing the excess starch and water solution from the saturated substrate, then;
c) heating the saturated substrate to cross-link the starch;
d) washing the filter to remove the excess starch; and
e) drying the substrate to remove excess water.

17. An integrated filter for removing impurities from a fluid stream, the filter comprising:
a) a first element adapted to remove at least some of the impurities by physical absorption; and
b) a second element adapted to remove at least some of the impurities by electrokinetic adsorption, said second element being coated with a crosslinked functionalized cationically charged, silicon containing carbohydrate, capable of crosslinking without a secondary crosslinking agent.

18. The integrated filter of claim 17, in which the first element further is adapted to remove at least some of the impurities by sieving.

19. The integrated filter of claim 17, in which the second element further is adapted to remove at least some of the impurities by sieving.

20. The integrated filter of claim 17, in which the first element is comprised of a porous block of an adsorbent, wherein the block is permeable to fluids and has interconnected pores therethrough.

21. The integrated filter of claim 17, in which the first element further is comprised of a granular adsorbent component and a thermoplastic binder component.

22. The integrated filter of claim 17, in which the adsorbent is activated carbon, activated alumina, activated bauxite, fuller's earth, diatomaceous earth, silica gel, or calcium sulfate.

23. The integrated filter of claim 17, in which the second element is comprised of a porous, charge-modified fibrous web comprising fibers prepared from a thermoplastic polymer.

24. The integrated filter of claim 23, in which the thermoplastic polymer is a polyolefin.

25. The integrated filter of claim 23, in which the porous, charge-modified fibrous web is a meltblown web.

26. The integrated filter of claim 17, in which the second element is comprised of glass.

27. A method for filtering water for bacteria, by passing water to be filtered across a fibrous filter wherein the fibers of the filter have been coated with a functionalized cationically charged silicon containing carbohydrate polymer that has been crosslinked by heat.
